(19) United States
(12) Patent Application Publication
(10) Pub. No.: US 2017/0276862 A1
(43) Pub. Date: Sep. 28, 2017

(54) EDGE-LIT LIGHT GUIDE BOARD, BACK LIGHT MODULE, FABRICATION METHOD THEREOF AND DISPLAY DEVICE

(71) Applicants: BOE TECHNOLOGY GROUP CO., LTD., Beijing (CN); BOE OPTICAL SCIENCE AND TECHNOLOGY CO., LTD., Suzhou, Jiangsu (CN)

(72) Inventor: Zhiqiang WANG, Beijing (CN)

(21) Appl. No.: 15/504,964

(22) PCT Filed: Aug. 5, 2016
(86) PCT No.: PCT/CN2016/093609

§ 371 Date: Feb. 17, 2017

(30) Foreign Application Priority Data
Oct. 8, 2015 (CN) 201510641708.X

(51) Int. Cl. F21V 8/00

(52) U.S. Cl. CPC G02B 6/0038; G02B 6/0016; G02B 6/0073

(57) ABSTRACT

An edge-lit light guide board, a manufacturing method thereof, a backlight module and a display device are provided. In the edge-lit light guide board, a first groove is formed in the light guide board, the first groove is located at an edge of a first side of the light guide board and is spaced apart from the edge of the first side, and a side surface of the light guide board on the first side is a light incident surface.

### TECHNICAL FIELD

The present disclosure relates to an edge-lit light guide board, a back light module, a fabrication method thereof and a display device.

### BACKGROUND

A back light module of a conventional liquid crystal display of a side-lit type has a structure as illustrated in FIG. 1, comprising a light guide board 100 and a light-emitting diode (LED) light bar 200 provided on a side of the light guide board 100. A plurality of LEDs 210 is distributed on a side of the LED light bar 200 facing one side of the light guide board 100, and light emitted from the plurality of LEDs 210 passes through a light incident surface of the light guide board 100, enters the light guide board 100 and then is emitted upward. Since the LED light bar 200 is provided on the left side of the light guide board 100, brightness of the light guide board 100 on the left side is great, so that brightness at an edge of the left side of a display region is higher than brightness of other display regions, which forms a bright line in a display screen.

### SUMMARY

Some embodiments of the disclosure provide an edge-lit light guide board, wherein, a first groove is formed in the light guide board, the first groove is located at an edge of a first side of the light guide board and is spaced apart from the edge of the first side, and a side surface of the light guide board on the first side is a light incident surface.

In some examples, the first groove is configured to refract light incident on the first groove, so that a position where the light arrives at a light emergent surface of the light guide board is shifted toward the first side.

In some examples, an opening of the first groove is located on the light emergent surface of the light guide board.

In some examples, there is one first groove formed at the edge of the first side of the light guide board, an extending direction of the first groove is consistent with an extending direction of the edge of the first side, and a length in the direction is consistent with a length of a light-emitting portion of a light-emitting source which is adapted to the light guide board.

In some examples, there is a plurality of first grooves formed at the edge of the first side of the light guide board, the plurality of first grooves extending and arranged along the edge of the first side.

In some examples, there is a plurality of V-shaped second grooves formed on the light incident surface of the light guide board, and the second grooves are used for scattering light incident into a main body of the light guide board.

In some examples, two side walls of the first groove are parallel to the light incident surface.

In some examples, the light incident surface of the light guide board has a grinding surface structure.

Some embodiments of the disclosure provide a fabrication method of a light guide board, comprising: providing an original plate of a light guide board; etching a first groove at an edge of a first side of the original plate of the light guide board, the first groove being spaced apart from the edge of the first side, and a side surface of the light guide board on the first side being a light incident surface.

Some embodiments of the disclosure provide a back light module, comprising the light guide board as mentioned above.

In some examples, the back light module further comprises a light absorbing layer provided at an edge of the first side and opposite to the light emergent surface of the light guide board.

In some examples, the back light module further comprises an edge-lit light source, the edge-lit light source including a plurality of light-emitting units, the plurality of light-emitting units being arranged in a direction along the edge of the first side of the light guide board.

Some embodiments of the disclosure provide a display device, comprising the back light module as mentioned above.

In some examples, the display device comprises a display region and a non-display region on a periphery of the display region, and the first groove of the light guide board being located in the non-display region of the display device.

### BRIEF DESCRIPTION OF THE DRAWINGS

In order to clearly illustrate the technical solution of the embodiments of the present disclosure, the drawings of the embodiments will be briefly described in the following; it is obvious that the described drawings are only related to some embodiments of the present disclosure and thus are not)imitative of the present disclosure.

FIG. 1 is a structural schematic diagram of a back light module according to the prior art;

FIG. 2 is a plan view of a back light module provided by a first embodiment of the present disclosure;

FIG. 3 is a longitudinal sectional view of a back light module provided by the first embodiment of the present disclosure;

FIG. 4 is a plan view of a back light module provided by a second embodiment of the present disclosure.

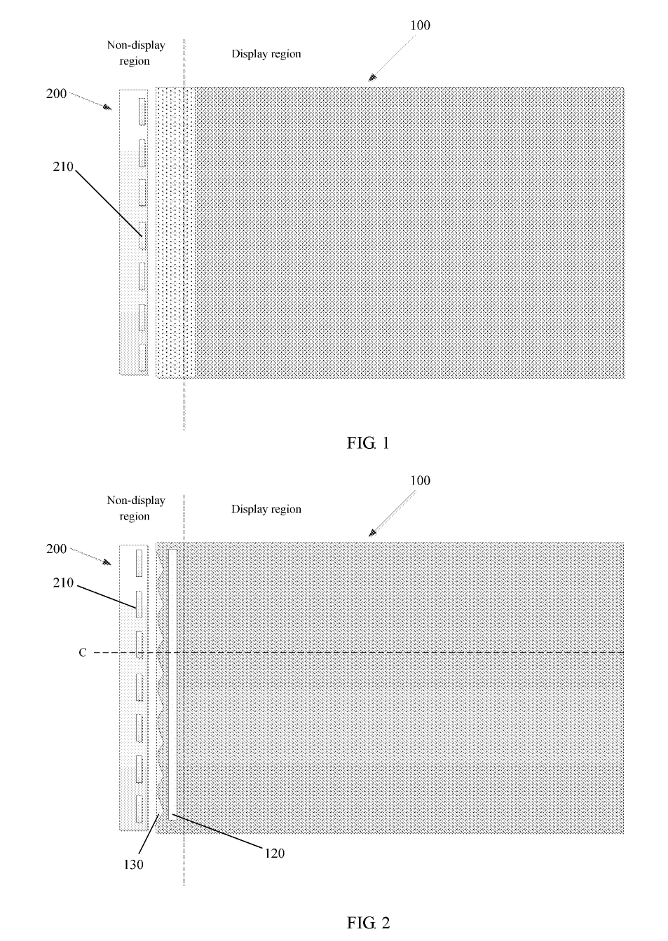

### DETAILED DESCRIPTION

In order to make objects, technical details and advantages of the embodiments of the present disclosure apparent, the technical solutions of the embodiment will be described in a clearly and fully understandable way in connection with the drawings related to the embodiments of the present disclosure. It is obvious that the described embodiments are just a part but not all of the embodiments of the present disclosure. Based on the described embodiments herein, those skilled in the art can obtain other embodiment(s), without any inventive work, which should be within the scope of the present disclosure.

In a first aspect, the present disclosure provides an edge-lit light guide board, the light guide board having a first groove formed therein, the first groove being located at an edge of a first side of the light guide board, which is capable of refracting light incident on the first groove, so that a position where the light arrives at a light emergent surface of the light guide board is shifted toward the first side, and a side surface of the light guide board on the first side being a light incident surface.

In the edge-lit light guide board provided by the present disclosure, the first groove is located at the edge of the first side of the light guide board, such that the light incident on the first groove can be refracted, and the position where the light arrives at the light emergent surface of the light guide board is shifted toward the first side; and the side surface of the light guide board on the first side is the light incident surface. In this way, light which should have been emitted in a bright line region of the light emergent surface is shifted to a non-display region of the light emergent surface to be emitted, so as to reduce display brightness of the bright line region, and weaken a bright line phenomenon.

In a second aspect, the present disclosure further provides a fabrication method of a light guide board, for fabricating the light guide board as described in the first aspect, the method comprising: providing an original plate of a light guide board; etching a first groove at an edge of a first side of the light guide board, the first groove being capable of refracting light incident on the first groove, so that the position where the light arrives at a light emergent surface of the light guide board is shifted toward the first side, and a side surface of the light guide board on the first side being a light incident surface.

In a third aspect, the present disclosure provides a back light module, the back light module comprising the light guide board as described in the first aspect.

When specifically implemented, a specific structure of the light guide board as described above may be embodied in many different forms, and a specific structure of the back light module comprising the corresponding light guide board and the method for fabricating the light guide board may also be slightly different; hereinafter, it will be illustrated in detail in conjunction with the drawings.

### First Embodiment

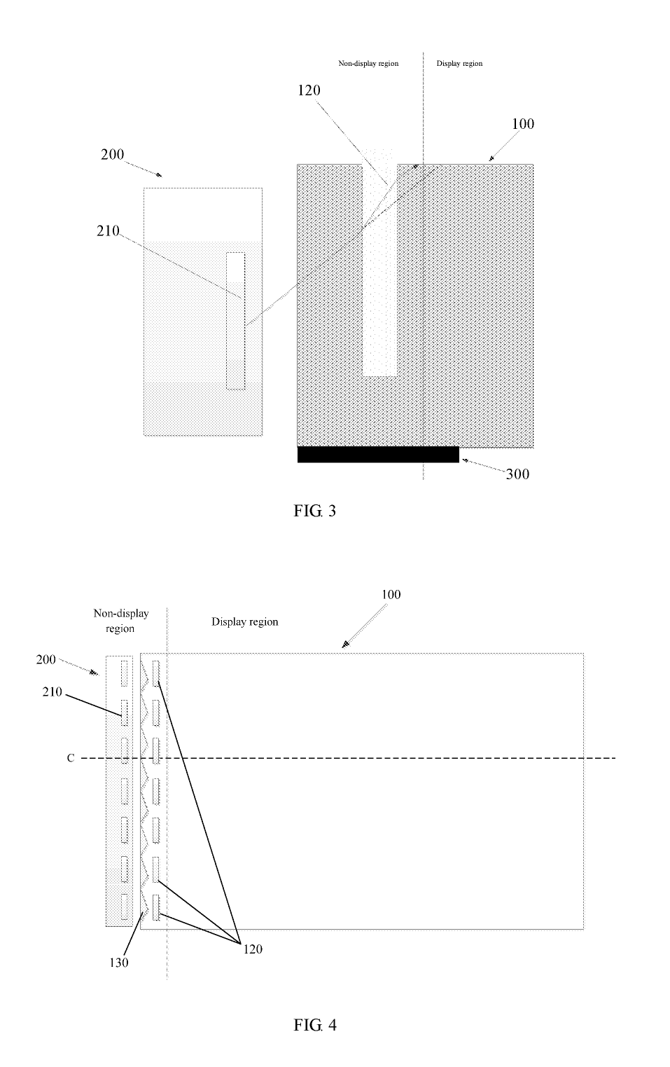

For a structure of the light guide board provided in the first embodiment of the present disclosure, FIG. 2 and FIG. 3 may be referred to, in which the light guide board is represented as 100. For convenience of explanation, it is assumed that a left surface of the light guide board 100 is a light incident surface, a light-emitting source 200 is provided on the left side of the light guide board 100, and an upper surface of the light guide board 100 is a light emergent surface. FIG. 2 illustrates a structure of the light guide board 100 when viewed from above, and FIG. 3 illustrates a structure of the light guide board 100 in a first longitudinal section of position C at a position close to a light incident side in FIG. 2, and the first longitudinal section is a section perpendicular to the light incident surface. With reference to FIG. 2 and FIG. 3, a first groove 120 or a plurality of second grooves 130 is formed in the light guide board 100. The first groove 120 is located at an edge of the left side of the light guide board 100, generally rendering as an elongated strip, and extending along the edge of the left side; and its section in the first longitudinal section is a rectangle, its left side wall and its right side wall are both parallel to the light incident surface, and a length of the first groove 120 is consistent with a length of a light-emitting region (the light-emitting region is a region of respective light-emitting units 210 plus a region between the light-emitting units 210) of the light-emitting source 200 (approximately the same as the light-emitting region of the light-emitting source, for example, slightly greater than the length of the light-emitting region); the second groove 130 is provided on the light incident surface of the light guide board 100, running through a main body portion of the light guide board 100 in a direction perpendicular to the light emergent surface, and is substantially a V-shape in a plan view. Here, the first groove 120 is located at the edge of the left side of the light guide board 100, which refers to that the first groove is located near the edge of the left side of the light guide board. As illustrated in FIG. 3, there is a gap between the first groove 120 and the edge of the left side, and a size of the gap may be set according to an actual situation. For example, in the display device, the first groove 120 of the light guide board may be located in the non-display region in the peripheral of the display device.

With reference to FIG. 3, when light incident from the left side into the main body of the light guide board 100 passes through the first groove 120, it is refracted twice; and since a refractive index of air in the first groove 120 is smaller than a refractive index of the main body of the light guide board 100, a final emergent position of the light on the light emergent surface of the light guide board 100 is shifted toward the left side as compared with the emergent position on the light emergent surface of the light guide board 100 in a case where light is not refracted in the first groove 120. In this way, a portion of light which should have been emitted from the bright line region of the light emergent surface is emitted from the non-display region of the light emergent surface, and the light emitted from the non-display region will be shielded by other structures such as a plastic frame formed in the non-display region, so as to reduce brightness at the edge of the display region close to the non-display region, and weaken a bright line phenomenon.

Similarly, with reference to FIG. 2, in the embodiment of the present disclosure, the V-shaped second groove 130 is provided on the light incident surface of the light guide board 100, and these V-shaped grooves function as prisms. This causes light incident on the light guide board 100 to be scattered by the second groove 130. As a result, a bright spot phenomenon occurring at the edge of the display region can be reduced. Of course, simply to achieve a basic purpose of the present disclosure, here the second groove 130 is not a structure to be necessarily provided.

It is not difficult to understand that, although FIG. 2 and FIG. 3 illustrate a case where an opening of the first groove 120 is located on the upper surface of the light guide board 100, in actual use, by providing the opening of the first groove 120 on a lower surface of the light guide board 100, the basic purpose of the present disclosure can also be achieved, and the corresponding technical solution should also fall within the protection scope of the present disclosure. In addition, when specifically implemented, the left side wall and the right side wall of the first groove 120 are not necessarily parallel to the light incident surface, for example, in practical application, the side walls of the above-described first groove 120 may be set not to be perpendicular to the light emergent surface, but one of the side walls is inclined at a certain angle. In addition, in the practical application, the extending direction of the first groove 120 is not necessarily parallel to the above-described edge on the left side. Under the premise that the basic purpose of the present disclosure can also be achieved, technical solutions obtained from these simple variations of the light guide board provided by the embodiment of the present disclosure should all fall within the protection scope of the present disclosure.

For the structural schematic diagram of the back light module comprising the light guide board provided by the first embodiment of the present disclosure, FIG. 2 and FIG. 3 may also be referred to, and the back light module further comprises the light-emitting source 200 provided on the left side of the light guide board 100, the light-emitting source 200 including a plurality of light-emitting units 210, and the length of the light-emitting region of the light-emitting source 200 is consistent with the length of the first groove 120 in the light guide board 100.

As an alternative mode, the above-described back light module may further comprise a light absorbing layer 300 provided at the edge of the left side on the lower surface of the light guide board 100. In this way, light reflected on the above-described bright line region can be reduced, so as to further weaken the bright line. Specifically, here the light absorbing layer 300 may be a light-absorbing tape, and the light-absorbing tape is attached to the lower surface of the light guide board 100.

When specifically implemented, a method for fabricating the light guide board of the first embodiment may specifically comprise: providing an original plate of a light guide board; etching a strip-like groove at an edge of a first side on a light emergent surface of the original plate of the light guide board, a section of the groove in a first longitudinal section being a rectangle; etching a plurality of second grooves on a light incident surface of the original plate of the light guide board.

When specifically implemented, for a specific process of the etching procedure as described above, the prior art may be referred to, which will not be described in detail in the present disclosure.

### Second Embodiment

For a plan view of a specific structure of the light guide board 100 provided by the second embodiment of the present disclosure, FIG. 4 may be referred to, and for a schematic diagram of a first longitudinal section at the first groove 120, FIG. 3 may be referred to as well; what is different from the structure of the light guide board 100 provided by the first embodiment of the present disclosure is that, in the second embodiment of the present disclosure, there is a plurality of first grooves 120 provided at the edge of the left side, and each first groove 120 is applicable to refract light emitted from one light-emitting unit 210 in the corresponding light-emitting source 200 which is adapted to the light guide board 100. In this way, an overall volume of the first groove 120 in the light guide board 100 is reduced, so that strength of the light guide board 100 is increased and risk of breakage of the light guide board 100 is reduced.

With reference to FIG. 4, in the structure of the back light module of the light guide board 100 provided by the second embodiment of the present disclosure, the light-emitting source 200 includes a plurality of light-emitting units 210, each light-emitting unit 210 corresponds to a position of one first groove 120 in the light guide board 100, and the first groove 120 is applicable to refract light emitted from one light-emitting unit 210 in the corresponding light-emitting source 200 which is adapted to the light guide board 100, so that the light is deflected to the left side.

When specifically implemented, for other structural features of the light guide board 100 and the back light module comprising the light guide board 100 provided by the second embodiment of the present disclosure, the first embodiment may be referred to, which will not be described in detail herein.

It is not difficult to understand that, when specifically implemented, the above-described one first groove 120 may also correspond to the plurality of light-emitting units 210, to refract light emitted from the plurality of light-emitting units 210. Corresponding technical solutions can also achieve similar technical effects, and should fall within the protection scope of the present disclosure.

For a fabrication method of the light guide board provided by the second embodiment, the method for fabricating the light guide board provided by the first embodiment may be referred to, but what is different is that, it is necessary to etch a plurality of first grooves on the original plate of the light guide board.

### Third Embodiment

What is different between a light guide board provided by the third embodiment and the light guide boards provided by the first embodiment and the second embodiment is that, a grinding surface design is used in the light incident surface of the light guide board; since the grinding surface design can play a role in scattering light incident on the main body of the light guide board, the bright spot phenomenon can also be weakened as well.

In a fourth aspect, the present disclosure further provides a display device, comprising the back light module as described above. For example, the display device comprises a display region and a non-display region on a periphery of the display region, and the first groove of the light guide board is located in the non-display region of the display device.

The display device may be: E-paper, a mobile phone, a tablet personal computer, a television, a monitor, a laptop, a digital photo frame, a navigator, and any other product or component having a display function.

It is not difficult to understand that, the display device provided by the present disclosure may be a liquid crystal display device, or may also be other types of display device.

The foregoing embodiments merely are exemplary embodiments of the present disclosure, and not intended to define the scope of the present disclosure, and the scope of the present disclosure is determined by the appended claims.

The present application claims priority of the Chinese Patent Application No. 201510641708.X filed on Oct. 8, 2015, the disclosure of which are incorporated herein by its reference in its entirety as part of the present application.

1. An edge-lit light guide board, wherein, a first groove is formed in the light guide board, the first groove is located at an edge of a first side of the light guide board and is spaced apart from the edge of the first side, and a side surface of the light guide board on the first side is a light incident surface.

2. The edge-lit light guide board according to claim 1, wherein, the first groove is configured to refract light incident on the first groove, so that a position where the light arrives at a light emergent surface of the light guide board is shifted toward the first side.

3. The light guide board according to claim 1, wherein, an opening of the first groove is located on the light emergent surface of the light guide board.

4. The light guide board according to claim 1, wherein, there is one first groove formed at the edge of the first side of the light guide board, an extending direction of the first groove is consistent with an extending direction of the edge of the first side, and a length in the direction is consistent with a length of a light-emitting portion of a light-emitting source which is adapted to the light guide board.

5. The light guide board according to claim 1, wherein, there is a plurality of first grooves formed at the edge of the first side of the light guide board, the plurality of first grooves extending and arranged along the edge of the first side.

6. The light guide board according to claim 1, wherein, there is a plurality of V-shaped second grooves formed on the light incident surface of the light guide board, and the second grooves are used for scattering light incident into a main body of the light guide board.

7. The light guide board according to claim 1, wherein, two side walls of the first groove are parallel to the light incident surface.

8. The light guide board according claim 1, wherein, the light incident surface of the light guide board has a grinding surface structure.

9. A fabrication method of a light guide board, comprising:
providing an original plate of a light guide board;
etching a first groove at an edge of a first side of the original plate of the light guide board, the first groove being spaced apart from the edge of the first side, and a side surface of the light guide board on the first side being a light incident surface.

10. A back light module, comprising the light guide board according to claim 1.

11. The back light module according to claim 10, further comprising a light absorbing layer provided at an edge of the first side and opposite to the light emergent surface of the light guide board.

12. The back light module according to claim 10, further comprising an edge-lit light source, the edge-lit light source including a plurality of light-emitting units, the plurality of light-emitting units being arranged in a direction along the edge of the first side of the light guide board.

13. A display device, comprising the back light module according to claim 10.

14. The display device according to claim 13, comprising a display region and a non-display region on a periphery of the display region, and the first groove of the light guide board being located in the non-display region of the display device.

15. The light guide board according to claim 2, wherein, an opening of the first groove is located on the light emergent surface of the light guide board.

16. The light guide board according to claim 2, wherein, there is one first groove formed at the edge of the first side of the light guide board, an extending direction of the first groove is consistent with an extending direction of the edge of the first side, and a length in the direction is consistent with a length of a light-emitting portion of a light-emitting source which is adapted to the light guide board.

17. The light guide board according to claim 2, wherein, there is a plurality of first grooves formed at the edge of the first side of the light guide board, the plurality of first grooves extending and arranged along the edge of the first side.

18. The light guide board according to claim 2, wherein, there is a plurality of V-shaped second grooves formed on the light incident surface of the light guide board, and the second grooves are used for scattering light incident into a main body of the light guide board.

19. The light guide board according to claim 2, wherein, two side walls of the first groove are parallel to the light incident surface.

20. The light guide board according to claim 2, wherein, the light incident surface of the light guide board has a grinding surface structure.
